(19) United States
(12) Patent Application Publication
(10) Pub. No.: US 2013/0120366 A1
(43) Pub. Date: May 16, 2013

(54) DISPLAY PANEL WITH 3D CAPABILITY AND DISPLAY APPARATUS HAVING THE SAME

(71) Applicant: SAMSUNG DISPLAY CO., LTD., Yongin-City (KR)

(72) Inventors: Seung-Hoon LEE, Hwaseong-si (KR); Hae-Young YUN, Suwon-si (KR); Seung-Jun JEONG, Hwaseong-si (KR); Jin-Hwan KIM, Suwon-si (KR)

(73) Assignee: SAMSUNG DISPLAY CO., LTD., YONGIN-CITY (KR)

(21) Appl. No.: 13/651,018

(22) Filed: Oct. 12, 2012

(30) Foreign Application Priority Data
Nov. 15, 2011 (KR) 10-2011-0118645

(51) Int. Cl. G06T 15/00

(52) U.S. Cl. 345/419

(57) ABSTRACT

A display apparatus having a display panel and a lenticular plate is configured for displaying 3D images. The display panel includes a plurality of light output-controlling portions and a light blocking portion surrounding them. The light output-controlling portions each has a non-rectangular shape, for example a parallelogram shape. A width of the light blocking portion between adjacent light output-controlling portions is determined according to a repetition period of the light output-controlling portions and according to an inclination angle of the lenticular plate. The configuration prevents or suppresses perception of a Moiré artifact pattern.

### CROSS-REFERENCE TO RELATED APPLICATION

This application claims priority to Korean Patent Application No. 10-2011-0118645, filed on Nov. 15, 2011, and all the benefits accruing therefrom under 35 U.S.C. §119, where the contents of said application are incorporated herein by reference in their entireties.

### BACKGROUND

1. Field of Disclosure

The present disclosure of invention relates to a display panel and a display apparatus having the display panel. More particularly, the present disclosure of invention relates to a display panel capable of displaying a three-dimensional (3D) stereoscopic image and a display apparatus having the display panel.

2. Description of Related Technology

As demands for the 3D stereoscopic image creation increase in fields like computer driven game-playing, movie presentation and so on, different technologies for displaying 3D stereoscopic images have been developed. In one variation, a pair of two-dimensional (2D) images different from each other are respectively provided to the focal planes of respective eyes of an observer (user) such that the 3D stereoscopic image is perceived. For example, the observer watches a pair of different 2D images through his/her respective eyes, and then the 2D images are mixed in the observer's brain to be recognized as a 3D stereoscopic image.

The developed 3D stereoscopic display apparatuses may be classified as either a spectacle-based stereoscopic type or an auto-stereoscopic type depending on whether the observer has to wear specific glasses for achieving the application of different 2D images to the respective eyes. Conventionally, in the auto-stereoscopic type of display apparatus and more specifically, in the barrier type, in the lenticular type and so on, new features are added as additional layers to a flat display apparatus. In the lenticular type, light rays passing respectively from a left-eye serving pixel and a right-eye serving pixel are differently refracted by using a lenticular lens or the equivalent to direct the rays to the respective left and right eyes and thus display the 3D stereoscopic image.

The auto-stereoscopic type display apparatuses which use refracting lenses for directing the rays to the respective left and right eyes suffer from a number of drawbacks such as, that luminance changes according to a distance between the display apparatus and the observer, according to an angular position of the observer with respect to the display apparatus, according to a position of the image in the screen and relative to the lens that are affixed thereto, and so on. One of the resultant drawbacks of using lenses to differently focus on different parts of the display panel (e.g., on the different pixels) is that an artifact such as one or more black stripes or other artificial patterns may be perceived in the projected image. One variation of such stripes or other artifacts is called the Moiré effect and it is recognized by the observer as a pattern of black stripes where the pattern varies according to the position of the observer relative to the screen. The Moiré effect may be caused for example when the lens cause the user's eyes to become focused on light blocking portions (e.g., black matrix portions) of the pixels array structure of the display apparatus rather than on light output-controlling aperture portions and then the screen is seen as being totally or partially filled with black stripes.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

Example embodiments of the present disclosure of invention provide a display panel capable of displaying 3D images and uniformly maintaining luminance across the entire screen thereof while suppressing the appearance of unintended black stripes.

Example embodiments of the present disclosure of invention also provide a display apparatus having such a 3D-capable display panel.

According to an example embodiment of the present disclosure, a 3D-capable display panel includes a light output-controlling portion having a non-rectangular shape and a light blocking portion surrounding the light output-controlling portion where both of these features are repeated at a predetermined pitch. The non-rectangular shape of the light output-controlling portion includes a first long side extending along a vertical-axis direction, a second long side substantially parallel with the first long side, a first short side extending along a direction inclined by a first inclination angle with respect to a horizontal-axis direction, and a second short side substantially parallel with the first short side, and transmits light. The light blocking portion surrounds the light output-controlling portion and blocks the light.

In an example embodiment, the first long side may connect first and second apexes of the light output-controlling portion with each other, the second long side may connect third and fourth apexes of the light output-controlling portion with each other, the first short side may connect the first and fourth apexes of the light output-controlling portion with each other, and the second short side may connect the second and third apexes of the light output-controlling portion with each other.

In an example embodiment, the light output-controlling portion may include an (n−1)th light output-controlling portion, an (n)th light output-controlling portion and an (n+1)th light output-controlling portion extending along the horizontal-axis direction (n is a natural number). The first apex of the (n)th light output-controlling portion and the fourth apex of the (n−1)th light output-controlling portion may be in alignment with a first line, the second apex of the (n)th light output-controlling portion and the third apex of the (n−1)th light output-controlling portion may be in alignment with a second line, the third apex of the (n)th light output-controlling portion and the second apex of the (n+1)th light output-controlling portion may be in alignment with a third line, and the fourth apex of the (n)th light output-controlling portion and the first apex of the (n+1)th light output-controlling portion may be in alignment with a fourth line.

In an example embodiment, the first, second, third and fourth lines may be substantially parallel with each other and may be inclined by a second inclination angle with respect to the vertical-axis direction.

In an example embodiment, a horizontal width (Bx) of the light blocking portion between the light output-controlling portions adjacent to each other along the horizontal-axis direction may be determined according to a repetition period or pitch of the light output-controlling portions and the second inclination angle.

In an example embodiment, the second inclination angle may be determined by a horizontal width of the light blocking portion between the light output-controlling portions adjacent to each other along the horizontal-axis direction, a period of the light output-controlling portion and the first inclination angle.

In an example embodiment, the display panel may further include at least one electronic element and at least one signal line driving a pixel electrode included in the light output-controlling portion. The electronic element and the signal line may be disposed in an area in which the light blocking portion is disposed. The signal lines may extend along respective horizontal and vertical axes of the display panel.

According to another example embodiment of the present disclosure, a display apparatus includes a lens plate and a display panel. The lens plate includes a plurality of unit lenses or equivalent, and each unit lens has a lens axis inclined by a first inclination angle with respect to a vertical-axis direction of the display panel. The display panel faces the lens plate and includes a plurality of light output-controlling portions and a light blocking portion. The light output-controlling portion has a non-rectangular shape that includes a first long side extending along the vertical-axis direction, a second long side substantially parallel with the first long side, a first short side extending along a direction inclined by a second inclination angle with respect to a horizontal-axis direction, and a second short side substantially parallel with the first short side. The light blocking portion surrounds the light output-controlling portion.

In an example embodiment, the first long side may connect first and second apexes of the light output-controlling portion with each other, the second long side may connect third and fourth apexes of the light output-controlling portion with each other, the first short side may connect the first and fourth apexes of the light output-controlling portion with each other, and the second short side may connect the second and third apexes of the light output-controlling portion with each other.

In an example embodiment, the light output-controlling portion may include an (n−1)th light output-controlling portion, an (n)th light output-controlling portion and an (n+1)th light output-controlling portion extending along the horizontal-axis direction (n is a natural number). The first apex of the (n)th light output-controlling portion and the fourth apex of the (n−1)th light output-controlling portion may be in alignment with a first line, the second apex of the (n)th light output-controlling portion and the third apex of the (n−1)th light output-controlling portion may be in alignment with a second line, the third apex of the (n)th light output-controlling portion and the second apex of the (n+1)th light output-controlling portion may be in alignment with a third line, and the fourth apex of the (n)th light output-controlling portion and the first apex of the (n+1)th light output-controlling portion may be in alignment with a fourth line.

In an example embodiment, the first, second, third and fourth lines may be substantially parallel with the lens axis.

In an example embodiment, a horizontal width of the light blocking portion between the light output-controlling portions adjacent to each other along the horizontal-axis direction may be determined by a period of the light output-controlling portions and the first inclination angle.

In an example embodiment, the second inclination angle may be substantially same as the first inclination angle.

In an example embodiment, the horizontal width (Bx) of the light blocking portion may be calculated by Bₓ=Pₓ sin²θ. Px may be the period of the light output controlling portion and θ may be the first inclination angle.

In an example embodiment, the second inclination angle may be determined by a horizontal width of the light blocking portion between the light output-controlling portions adjacent to each other along the horizontal-axis direction, a period of the light output-controlling portion and the first inclination angle.

In an example embodiment, the second inclination angle (θp) may be calculated by

$$θ p = arctan [ \frac{{B}_{x}}{tan θ ( {P}_{x} - {B}_{x} )} ] .$$

Px may be the period of the light output-controlling portion, Bx may be the horizontal width of the light blocking portion and θ may be the first inclination angle.

In an example embodiment, the light output-controlling portion may include red, green and blue light output-controlling portions, and the red, green and blue light output-controlling portions may be arranged in a vertical stripes shape.

In an example embodiment, the light output-controlling portion may include red, green and blue light output-controlling portions, and the red, green and blue light output-controlling portions may be arranged in a horizontal stripes shape.

In an example embodiment, the light output-controlling portion may include red, green and blue light output-controlling portions, and the red, green and blue light output-controlling portions may be arranged in a mosaic pattern.

In an example embodiment, the display panel may further include at least one electronic element and at least one signal line driving a pixel electrode included in the light output-controlling portion. The electronic element and the signal line may be disposed in an area in which the light blocking portion is disposed. The signal line may extend along one of the horizontal and vertical axes of the display panel.

In an example embodiment, the first inclination angle may be between about 0° and about 45°.

According to the example embodiments of the present disclosure of invention, a light output-controlling portion has a luminance uniformly maintained regardless of a change of a lens's defocus. Thus, Moiré may be prevented from occurring due to an un-uniform luminance. In addition, an aperture ratio of a display panel and the lens's defocus are controlled to improve a crosstalk of a 3D stereoscopic image.

### BRIEF DESCRIPTION OF THE DRAWINGS

The above and other features and advantages of the present disclosure of invention will become more apparent by describing in detailed example embodiments thereof with reference to the accompanying drawings, in which:

FIG. 1 is a perspective view illustrating a display apparatus according to an example embodiment of the present disclosure;

FIG. 2 is a plan view illustrating a display panel in FIG. 1;

FIGS. 3A to 3C are graphs illustrating a luminance and a crosstalk of a plurality of light output-controlling portions arranged along a horizontal-axis direction X according to a position of the light output-controlling portions in the display panel of FIG. 2;

FIG. 4 is a plan view illustrating a display panel according to another example embodiment;

FIGS. 5A to 5C are graphs illustrating a luminance and a crosstalk of a plurality of light output-controlling portions arranged along a horizontal-axis direction X according to a position of the light output-controlling portions in the display panel of FIG. 3;

FIG. 6 is a plan view illustrating a display panel according to still another example embodiment;

FIGS. 7A to 7C are graphs illustrating a luminance and a crosstalk of a plurality of light output-controlling portions arranged along a horizontal-axis direction X according to a position of the light output-controlling portions in the display panel of FIG. 6;

FIG. 8 is a graph illustrating a uniformity of a luminance according to a defocus in the display apparatuses according the previous example embodiments in FIGS. 1, 4 and 6;

FIG. 9 is a graph illustrating a viewing angle according to the defocus in the display apparatuses according to the previous example embodiments in FIGS. 1, 4 and 6;

FIG. 10 is a graph illustrating a crosstalk according to an aperture ratio in the display apparatuses according to the previous example embodiments in FIGS. 1, 4 and 6;

FIG. 11 is a graph illustrating a crosstalk according to the defocus in the display apparatuses according to the previous example embodiments in FIGS. 1, 4 and 6;

FIGS. 12A and 12B are conceptual diagrams illustrating a luminance distribution in a pixel according to still another example embodiment;

FIGS. 13A and 13B are conceptual diagrams illustrating a luminance distribution in a pixel according to still another example embodiment;

FIGS. 14A and 14B are conceptual diagrams illustrating a luminance distribution in a pixel according to still another example embodiment;

FIG. 15 is a plan view illustrating a display panel according to still another example embodiment; and

FIG. 16 is a plan view illustrating a display panel according to still another example embodiment.

### DETAILED DESCRIPTION

Hereinafter, the present disclosure of invention will be explained in detail with reference to the accompanying drawings.

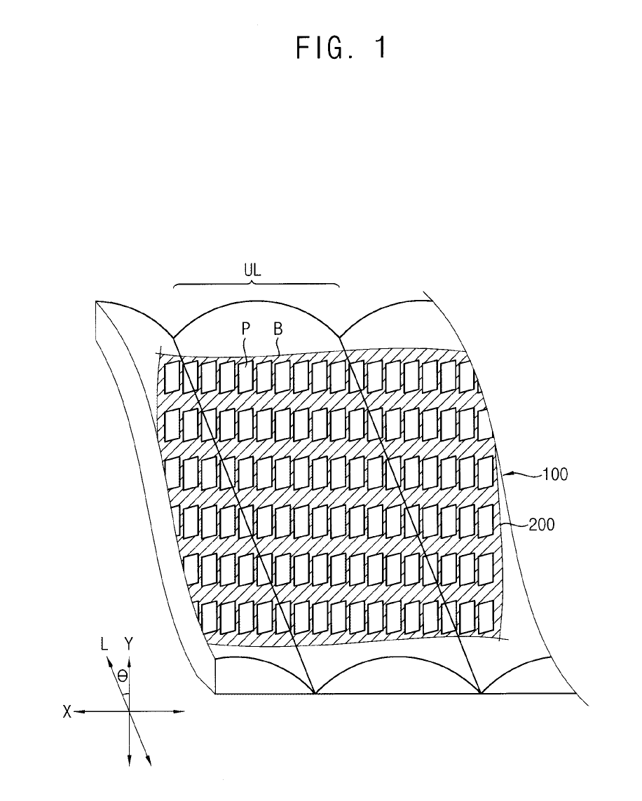

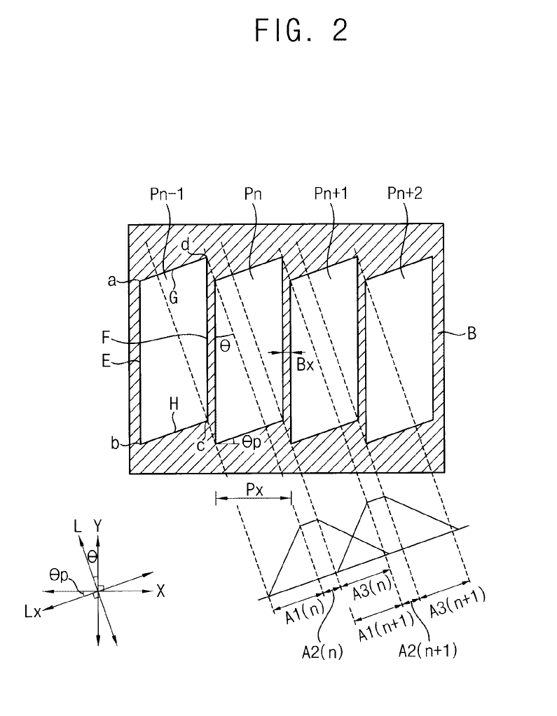

FIG. 1 is a perspective view illustrating a display apparatus according to an example embodiment of the present disclosure. FIG. 2 is a plan view illustrating a display panel in FIG. 1.

Referring to FIG. 1, the display apparatus according to the example embodiment includes a lens plate 100 (a.k.a. refraction plate) and a display panel 200 (a.k.a. light output-controlling portions panel).

The lens plate 100 (or other form of refraction plate) faces the display panel 200, and includes a plurality of unit lens (or other form of repeated refraction means). Each unit lens UL is elongated to extend along a longitudinal lens axis L inclined by a first inclination angle θ with respect to a vertical-axis direction Y of the display panel 200, and is arranged to repeat periodically along a horizontal-axis direction X crossing the vertical-axis direction Y. The first inclination angle θ may be between about 0° and about 45°. The unit lens UL has a respective lens width, and the lens width corresponds to a plurality of light output-controlling portions that are disposed to provide a preset plurality of multi-eye viewing points.

The unit lens UL (or other form of refraction means) refracts light rays passed to it from the light output-controlling portions of the display panel 200 to focal positions corresponding to the multi-eye viewing points used by the observer to view 3D images. The unit lens UL may include a Fresnel lens, a lenticular lens and/or other forms of refraction means.

The lens plate 100 (a.k.a. refraction plate) may be in the form of a lens film formed by patterning an optical plate to have the unit lens UL repeated there across. Alternatively, the lens plate 100 (a.k.a. refraction plate) may be a lens-defining liquid crystal panel including a plurality of patterned electrodes and a liquid crystal layer forming the optical equivalent of the repeated unit lens UL. When the lens plate 100 is the lens film, the display apparatus generally displays only three-dimensional (3D) stereoscopic image. When the lens plate 1000 is the liquid crystal lens panel, the display apparatus controls the liquid crystal lens panel to selectively display either a two-dimensional (2D) image or the 3D stereoscopic image depending on the electrically controlled configuration of the liquid crystal lens panel.

The display panel 200 includes a plurality of light output-controlling portions P and a light blocking portion B surrounding the light output-controlling portions P. Each of the light output-controlling portions P includes an output controlling pixel electrode. An electrical charge applied to the pixel electrode controls an output of light from the controlling portion P, for example the amount of transmittance of light through the controlling portion P where the light is sourced from a backlighting unit provided at a rear surface of the display panel 200. The light blocking portion B blocks light. The light blocking portion B may provided light blockage for at least one overlapped electronic element and for at least one signal line segment where the signal line segment is used to drive the pixel electrode. The electronic element may include a switching element (e.g., a thin film transistor), a storage capacitor and so on, and the signal line segment may be part of a data line, a gate line and so on. Alternatively, the light output-controlling portion P and the light blocking portion may include the electronic element and the signal line.

The light output-controlling portion P has a vertically-elongated parallelogrammic shape (a non-rectangular shape).

More specifically and referring to FIG. 2, in one embodiment the display panel 200 includes a plurality of light output-controlling portions . . . , Pn−1, Pn, Pn+1, Pn+2, . . . each having a vertically-elongated parallelogrammic shape. The light output-controlling portions each respectively output or pass therethrough a locally selected amount of light to thereby cause the display of images having preset multi-eye viewing points when operating in the 3D image mode. More specifically, the lens plate 100 cooperates with the pattern of lights output from the plural light output-controlling portions, Pn−1, Pn, Pn+1, etc. so that refracted light is perceived by a viewer as a 3D image when the viewer's eyes are disposed at predefined, multi-eye viewing points relative to the lens plate 100 and the display panel 200.

Yet more specifically and taking for example, the (n)th light output-controlling portion Pn, it has a vertically-elongated parallelogram shape including first, second, third and fourth apexes (corner points) a, b, c and d. The parallelogram shape includes a first long side E, a spaced apart second long side F, a first short side G and a spaced apart second short side H. The first long side E defines a corresponding first vertical line connecting the first and second apexes a and b with each other. The second long side F defines a corresponding second vertical line connecting the third and fourth apexes c and d with each other. The first short side G defines a corresponding first slanted line connecting the first and fourth apexes a and d with each other. The second short side H defines a corresponding second slanted line connecting the second and third apexes b and c with each other. The first and second long sides E and F are substantially parallel with the vertical-axis direction Y of the display panel. The first and second short sides G and H are inclined with respect to the horizontal-axis direction X of the display panel, the inclination or slant being defined by a second inclination angle θp. The second inclination angle θp may be substantially same as the first inclination angle θ. For example, the first and second short sides, G and H are substantially perpendicular to the lens axis L. The drawing also shows a horizontal lens axis Lx that is substantially perpendicular to the lens axis L and thus parallel to the first and second short sides, G and H.

Between horizontally adjacent light output-controlling portions, (e.g., Pn, Pn+1) there is a thin width, denoted as Bx, of the light blocking portion B. In other words, this thin portion is disposed between the second long side F of the (n)th light output-controlling portion Pn and the first long side E of the (n+1)th light output-controlling portion Pn+1, it has a width Bx measured along the X direction and it has a repetition period Px which also happens to be the repetition period or pitch in the X direction of the light output-controlling portions. Throughout this disclosure, n is a natural number. In one embodiment, the width BX along the horizontal-axis direction X of the thin parts of the light blocking portion B is calculated by the following Equation 1:

Bₓ=Pₓ sin²θ [Equation 1]

where, the angle θ is the first inclination angle and Px is the repetition period or pitch in the X direction of the light output-controlling portions.

In FIG. 2, a first dashed line is drawn from the fourth apex d of the (n−1)th light output-controlling portion Pn−1 through the first apex a of the (n)th light output-controlling portion Pn so that this first dashed line is substantially parallel with the lens axis L. A second dashed line is drawn from the third apex c of the (n−1)th light output-controlling portion Pn−1 through the second apex b of the (n)th light output-controlling portion Pn so that this second dashed line is substantially parallel with the lens axis L. A third dashed line is drawn from the fourth apex d of the (n)th light output-controlling portion Pn to the first apex a of the (n+1)th light output-controlling portion Pn+1 so that this third dashed line is substantially parallel with the lens axis L. A fourth dashed line is drawn from the third apex c of the (n)th light output-controlling portion Pn through the second apex b of the (n+1)th light output-controlling portion Pn+1 so that this fourth dashed line is substantially parallel with the lens axis L.

The (n)th light output-controlling portion Pn contributes its light to a corresponding (n)th viewing-point image according to a refraction distribution aspect of the lens plate 100. This luminance contribution and distribution aspect of the (n)th light output-controlling portion Pn may be seen as being divided among first, second and third adjacent areas A1n, A2n and A3n, as shown in FIG. 2 where the areas are deemed as extending along the Lx axis of the unit lens UL having the lens axis L. In the first area A1n of the (n)th light output-controlling portion Pn, the contributed luminance gradually increases to a maximum level due to action of the adjacent Bx portion of the light blocking portion B. In the second area A2n of the (n)th light output-controlling portion Pn, the contributed luminance is considered to be the maximum contribution level provided by the Pn controlling portion. In the third area A3n of the (n)th light output-controlling portion Pn, the luminance gradually decreases from the maximum level down to substantially zero due to the presence of the adjacent Bx portion of the light blocking portion B. In addition, and although not shown in FIG. 2, in the first light contribution area A1n, a crosstalk contribution may occur due to an (n−1)th viewing-point image projected from the adjacent (n−1)th light output-controlling portion Pn−1 to the first area A1n. Similarly, in the third light contribution area A3n of the (n)th portion Pn, a crosstalk contribution may occur due to an (n+1)th viewing-point image contribution provided by the (n+1)th light output-controlling portion Pn+1 adjacent to the third area A3n.

The (n+1)th light output-controlling portion Pn+1 similarly contributes to the (n+1)th viewing-point image. A luminance contribution and distribution pattern of the (n+1)th light output-controlling portion Pn+1 is similarly divided into respective first, second and third areas A1(n+1), A2(n+1) and A3(n+1) by action of the unit lens UL having the lens axis L. In the first area A1(n+1) of the (n+1)th light output-controlling portion Pn+1, the luminance gradually increases to a maximum level due to the (n)th light output-controlling portion Pn and the light blocking portion B. In the second area A2(n+1) of the (n+1)th light output-controlling portion Pn+1, the luminance is in the maximum level. In the third area A3(n+1) of the (n+1)th light output-controlling portion Pn+1, the luminance gradually decreases from the maximum level due to the light blocking portion B and the (n+2)th light output-controlling portion Pn+2.

The third area A3n of the (n)th light output-controlling portion Pn overlaps with the first area A1(n+1) of the (n+1)th light output-controlling portion Pn+1. In the third area A3n of the (n)th light output-controlling portion Pn, the luminance gradually decreases from the maximum level, but in the first area A1(n+1) of the (n+1)th light output-controlling portion Pn+1, the luminance gradually increases to a maximum level. Thus, due to these overlapping light contributions where otherwise the black of the thin portion Bx of the blocking portion B would appear, the user-perceived luminance may be more uniformly distributed, and thus Moiré artifact effect may be prevented from occurring due to the repeated presence of the repeated thin portions Bx of the light blocking portion B.

If the lenticular lens were not rotated by the first inclination angle, θ such that a viewer with head held in the normal vertical orientation would see all of the left side image projected essentially to the left eye and all of the right side image projected essentially to the right eye, then the normal aperture ratio in which the light passes through an entire display area of the display panel fully to the intended eyes may be deemed to be about 100%. In that case, the display panel having the lenticular lens rotated by the first inclination angle θ relative to the vertical and having the light output-controlling portions shaped and spaced apart according to the present example embodiment may have the effective aperture ratio of about 67%. As the left and right images become more mixed due to increase of the first inclination angle θ, the aperture ratio also increases due to increased luminance from the image being more mixed. Thus, the aperture ratio may be increased but as a trade off with a left and right images crosstalk ratio.

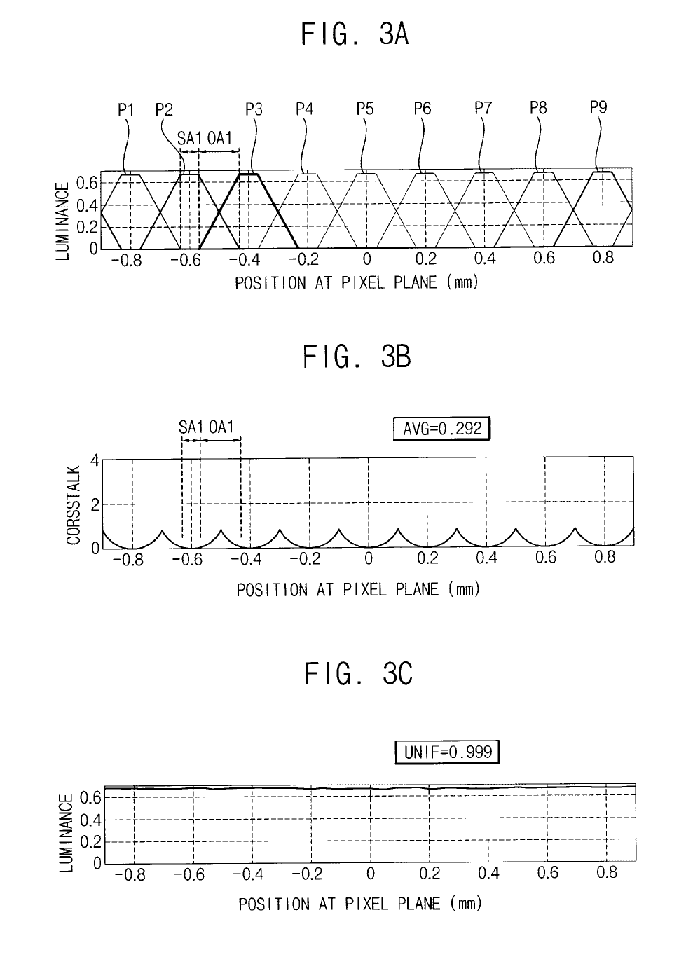

FIGS. 3A to 3C are graphs respectively illustrating luminance mixture from contributions from adjacent light output-controlling portions, Pn−1, Pn, etc. and a crosstalk factor of a plurality of light output-controlling portions arranged along a horizontal axis(X) direction according to relative positions of the light output-controlling portions in the display panel of FIG. 2 where light output-controlling portion P5 is deemed the zero position

More specifically, in FIG. 3A, the luminance distribution and contributions are illustrated for the light output-controlling portions denominated as P1, P2, . . . , P9. In FIG. 3B, the crosstalk factor is illustrated for the light output-controlling portions P1, P2, . . . , P9 relative to the center of P5 being deemed as the zero position (0 mm) In FIG. 3C, the sum of the luminance contributions of the light output-controlling portions P1, P2, . . . , P9 is illustrated. Here, the aperture ratio may be about 67% on the display panel having the light output-controlling portions configured as described above.

Referring to the specifics of FIG. 3A, the individual luminance distribution and contribution of each of the light output-controlling portions has a first individual-alone or self-contribution area SA1 having the maximum level, and a first overlapping contribution area OA1 in which contribution from an adjacent light output-controlling portion overlaps.

In the first overlapping area OA1 plus a second (OA2 not shown) of the other light output-control portion, the respective contributions of the second and third light output-controlling portions P2 and P3 overlap with each other, and although the luminance contribution gradually decreases for the second light output-controlling portion P2, the luminance contribution gradually increases for the third light output-controlling portion P3, such that the decreasing contribution of P2 is countered by the increasing luminance contribution (which has positive inclination) of P3. Due to symmetry and the counter-balancing respective same rates of luminance decrease and luminance increase per distance from center of P2 and P3 respectively, the absolute totaled quantity of the luminance contributions produce a relatively constant level of totaled luminance. Thus, in the first overlapping area OA1, the increase of the luminance of the P3 contribution is substantially same as the decrease of the luminance of the P2 contribution, and thus the luminance is uniformly distributed.

Referring to FIGS. 3A and 3B, a crosstalk is about 0 in the first self area SA1 of each of the light output-controlling portions, and a crosstalk with an image displayed on the light output-controlling portion adjacent to the first overlapping area OA1 increased. Reviewing the measurement, an average crosstalk factor in one simulation was seen as about 0.292. The crosstalk is a regular value of the crosstalk with the images having viewing points different from that of the image displayed on the adjacent light output-controlling portion. The simulated crosstalk was calculated by Equation 2 as follows.

Crosstalk={(Σ(intensity of noise image))/intensity of signal image} [Equation 2]

Referring to FIGS. 3A and 3C, the sum of the luminances of the light output-controlling portions P1, P2, . . . , P9 was about 0.69 and was substantially uniformly distributed. The degree of uniformity of the luminance of the display apparatus was about 0.999. According to the present example embodiment therefore, the display apparatus may have substantially uniform distribution of luminance as perceived by the viewer.

Hereinafter, same reference numerals and drawings will be used for the elements substantially same as those in the previous example embodiment.

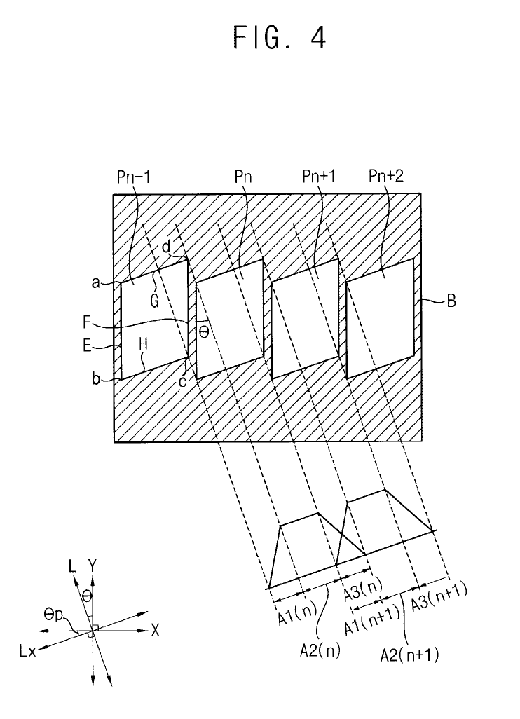

FIG. 4 is a plan view illustrating a display panel according to another example embodiment in accordance with the present disclosure of invention.

Referring to FIG. 4, a light output-controlling portion of the display panel according to the present example embodiment is substantially same as that according to the previous example embodiment in FIG. 2 except that a size (e.g., relative vertical height of each parallelogram) of the light output-controlling portions is decreased as compared to that according to the previous example embodiment in FIG. 2 while the light blocking portion B remains substantially the same, which means that the light output-controlling portion has a relatively lower aperture ratio. The aperture ratio of the display panel according to the present example embodiment is about 45%.

For example, an (n)th light output-controlling portion Pn has a parallelogram shape with first, second, third and fourth apexes a, b, c and d, and includes a first long side E, a second long side F opposite to the first long side E, a first short side G and a second short side H opposite to the first short side G. A horizontal width (Bx) of the light blocking portion may be calculated by Equation 1, and is determined by a period Px of the (n+1)th light output-controlling portion Pn+1 and a first inclination angle θ of the lens axis L.

A first dashed line is drawn from the fourth apex d of the (n−1)th light output-controlling portion Pn−1 to the first apex a of the (n)th light output-controlling portion Pn and is substantially parallel with the lens elongation axis L. A second dashed line is drawn from the third apex c of the (n−1)th light output-controlling portion Pn−1 to the second apex b of the (n)th light output-controlling portion Pn and is substantially parallel with the lens axis L. A third dashed line is drawn from the fourth apex d of the (n)th light output-controlling portion Pn to the first apex a of the (n+1)th light output-controlling portion Pn+1 and is substantially parallel with the lens axis L. A fourth dashed line is drawn from the third apex c of the (n)th light output-controlling portion Pn to the second apex b of the (n+1)th light output-controlling portion Pn+1 and is substantially parallel with the lens axis L.

A luminance distribution and contribution of the (n)th light output-controlling portion Pn is shown as divided into first, second and third areas A1n, A2n and A3n by action of the unit lens UL. In the first area A1n of the (n)th light output-controlling portion Pn, the luminance gradually increases to a maximum level. In the second area A2n of the (n)th light output-controlling portion Pn, the luminance is in the maximum level. In the third area A3n of the (n)th light output-controlling portion Pn, the luminance gradually decreases from the maximum level to zero.

A luminance distribution of the (n+1)th light output-controlling portion Pn+1 is divided into first, second and third areas A1(n+1), A2(n+1) and A3(n+1), by action of the unit lens UL. In the first area A1(n+1) of the (n+1)th light output-controlling portion Pn+1, the luminance gradually increases to a maximum level. In the second area A2(n+1) of the (n+1)th light output-controlling portion Pn+1, the luminance is in the maximum level. In the third area A3(n+1) of the (n+1)th light output-controlling portion Pn+1, the luminance gradually decreases from the maximum level.

The third area A3n of the (n)th light output-controlling portion Pn overlaps with the first area A1(n+1) of the (n+1)th light output-controlling portion Pn+1. In the third area A3n of the (n)th light output-controlling portion Pn, the luminance contribution gradually decreases from the maximum level, but in the first area A1(n+1) of the (n+1)th light output-controlling portion Pn+1, the luminance contribution gradually increases to a maximum level. Thus, the summed luminance contributions may be uniformly distributed, and thus Moiré may be prevented from occurring due to what would otherwise be a non-uniform distribution of luminance.

The first overlap areas, A1n and A1(n+1) and/or the second overlap areas, A3n and A3(n+1) according to the present example embodiment are smaller relative to A2(n) than those according to the previous example embodiment in FIG. 2. Thus, as the aperture ratio decreases, the crosstalk with the image having the different viewing point displayed on the adjacent light output-controlling portion may decrease due to relative increase of area A2(n) versus A1(n) and versus A3(n).

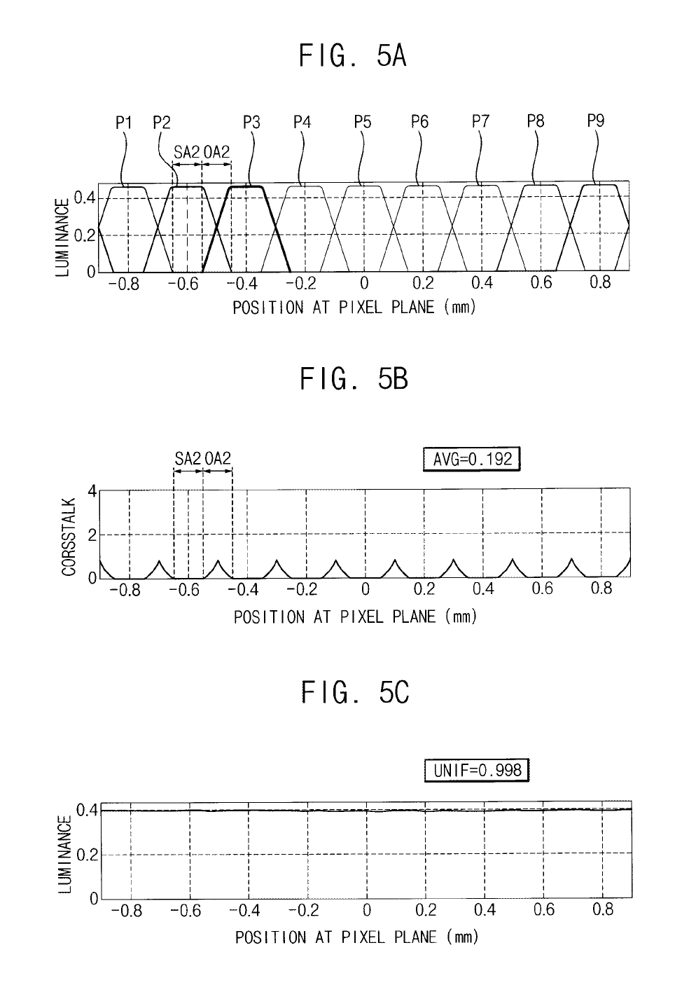

FIGS. 5A to 5C are graphs respectively illustrating luminance contributions and crosstalk of a plurality of light output-controlling portions arranged along a horizontal-axis(X) direction according to a position of the light output-controlling portions in the display panel of FIG. 3.

In FIG. 5A, the luminance distribution and contribution is illustrated on the light output-controlling portions P1, P2, . . . , P9. In FIG. 5B, the crosstalk is illustrated on the light output-controlling portions P1, P2, . . . , P9. In FIG. 5C, the sum of the luminance of the light output-controlling portions P1, P2, . . . , P9 is illustrated. Here, the aperture ratio may be about 45% on the display panel having the light output-controlling portions of FIG. 4.

Referring to FIG. 5A, the luminance distribution of each of the light output-controlling portions has a second self area SA2 having the maximum level, and a second overlapping area OA2 in which adjacent light output-controlling portions overlaps with each other. Compared to the first self area SA1 and the first overlapping area OA1 illustrated in FIG. 3A, the second self area SA2 is larger than the first self area SA1, and the second overlapping area OA2 is smaller than the first overlapping area OA1. Thus crosstalk is reduced.

In the second overlapping area OA2 in which the second and third light output-controlling portions P2 and P3 overlaps with each other, the luminance gradually decreases in the second light output-controlling portion P2, which means that the luminance contribution thereof has negative inclination, and the luminance gradually increases in the third light output-controlling portion P3, which means that the luminance contribution thereof has positive inclination. An absolute value of the negative inclination of the luminance in the second light output-controlling portion P2 is substantially same as the absolute value of the positive inclination of the luminance in the third light output-controlling portion P3. Thus, in the first overlapping area OA1, the increase of the luminance is substantially same as the decrease of the luminance, and thus the luminance is uniformly distributed.

Referring to FIGS. 5A and 5B, a crosstalk was about 0 in the second self area SA2 of each of the light output-controlling portions, and a crosstalk with an image displayed on the light output-controlling portion adjacent to the second overlapping area OA2 increased. Reviewing the simulated measurement, an average crosstalk was about 0.192.

Referring to FIGS. 5A and 5C, the sum of the luminance of the light output-controlling portions P1, P2, . . . , P9 was about 0.49 and was uniformly distributed. The uniformity of the luminance of the display apparatus was about 0.998.

According to the present example embodiment, the display panel may have less uniform distribution of the luminance compared to the display panel having the aperture ratio of about 67%, but relatively uniform. In addition, the average crosstalk is less than that of the display panel having the aperture ratio of about 67%. Thus, as the aperture ratio decreases, the crosstalk may be estimated to decrease.

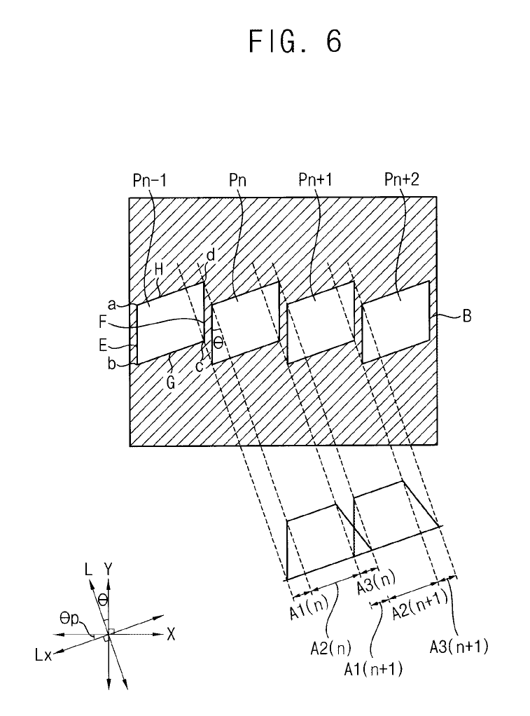

FIG. 6 is a plan view illustrating a display panel according to still another example embodiment of the present invention.

Referring to FIG. 6, a light output-controlling portion of the display panel according to the present example embodiment is substantially same as that according to the previous example embodiment in FIG. 2 except that a vertical height size of the light output-controlling portion is decreased yet further as compared to that according to the previous example embodiment in FIG. 3, which means that the light output-controlling portion has a relatively lower aperture ratio. The aperture ratio of the display panel according to the present example embodiment is about 20%.

According to the present example embodiment, a third area A3n of the (n)th light output-controlling portion Pn overlaps with a first area A1(n+1) of the (n+1)th light output-controlling portion Pn+1. In the third area A3n of the (n)th light output-controlling portion Pn, the luminance contribution gradually decreases, but in the first area A1(n+1) of the (n+1)th light output-controlling portion Pn+1 it gradually increases. Thus, the luminance may be uniformly distributed, and thus Moiré may be prevented from occurring due to an un-uniform distribution of the luminance.

In addition, the first area A1n and A1(n+1) or the second area A2n and A2(n+1) according to the present example embodiment is smaller than that according to the previous example embodiment in FIG. 3. Thus, as the aperture ratio decreases, the crosstalk with the image having the different viewing point displayed on the adjacent light output-controlling portion may decrease.

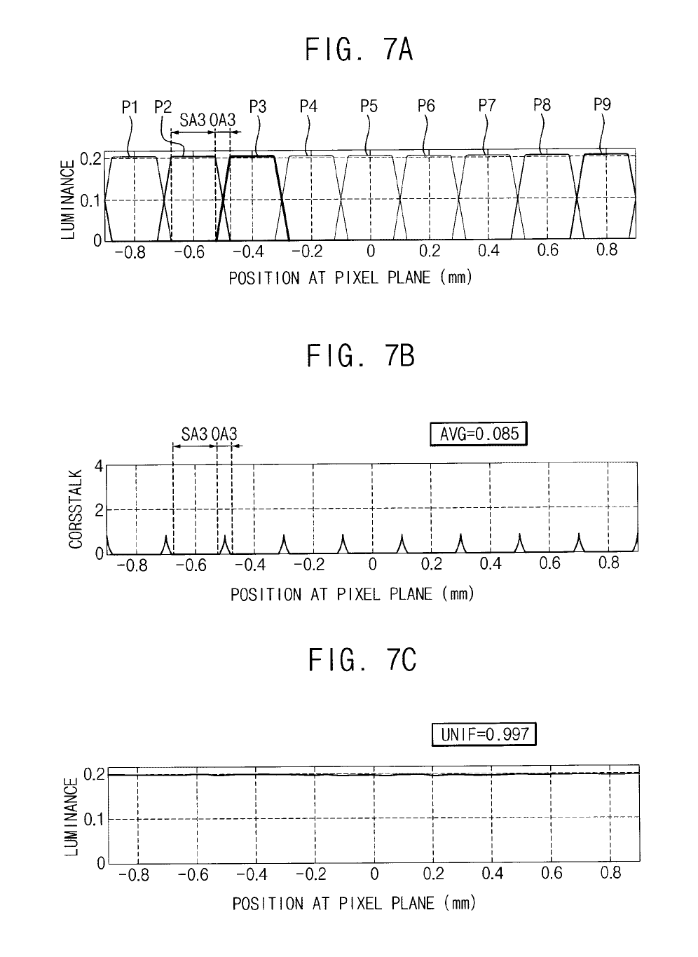

FIGS. 7A to 7C are graphs respectively illustrating luminance contribution and crosstalk of a plurality of light output-controlling portions arranged along a horizontal-axis(X) direction according to a position of the light output-controlling portions in the display panel of FIG. 6.

In FIG. 7A, the luminance distribution is illustrated on the light output-controlling portions P1, P2, . . . , P9. In FIG. 7B, the crosstalk is illustrated on the light output-controlling portions P1, P2, . . . , P9. In FIG. 7C, the sum of the luminance contributions of the light output-controlling portions P1, P2, . . . , P9 is illustrated. Here, the aperture ratio may be about 20% on the display panel having the light output-controlling portions.

Referring to FIG. 7A, the luminance distribution of each of the light output-controlling portions has a third self area SA3 having the maximum level, and a third overlapping area OA3 in which adjacent light output-controlling portions overlap with each other. Compared to the second self area SA2 and the second overlapping area OA2 illustrated in FIG. 5A, the third self area SA3 is larger than the second self area SA2, and the third overlapping area OA3 is smaller than the second overlapping area OA2.

In the third overlapping area OA3 in which the second and third light output-controlling portions P2 and P3 overlap with each other, the luminance contribution gradually decreases in the second light output-controlling portion P2, which means that the luminance has negative inclination, and the luminance gradually increases in the third light output-controlling portion P3, which means that the luminance has positive inclination. An absolute value of the negative inclination of the luminance in the second light output-controlling portion P2 is substantially same as the absolute value of the positive inclination of the luminance in the third light output-controlling portion P3. Thus, in the third overlapping area OA3, the increase of the luminance is substantially same as the decrease of the luminance, and thus the luminance is uniformly distributed.

Referring to FIGS. 7A and 7B, a crosstalk was about 0 in the third self area SA3 of each of the light output-controlling portions, and a crosstalk with an image displayed on the light output-controlling portion adjacent to the third overlapping area OA3 increased. Reviewing the simulated measurement, an average crosstalk was about 0.085.

Referring to FIGS. 7A and 7C, the sum of the luminance of the light output-controlling portions P1, P2, . . . , P9 was about 0.2 and was uniformly distributed. The uniformity of the luminance of the display apparatus was about 0.997.

According to the present example embodiment, the display panel may have less uniform distribution of the luminance compared to the display panel having the aperture ratio between about 48% and about 67%, but relatively uniform. In addition, the average crosstalk is the least among those of the display panels having the aperture ratio between about 48% and about 67%. Thus, as the aperture ratio decreases, the crosstalk may be estimated to decrease.

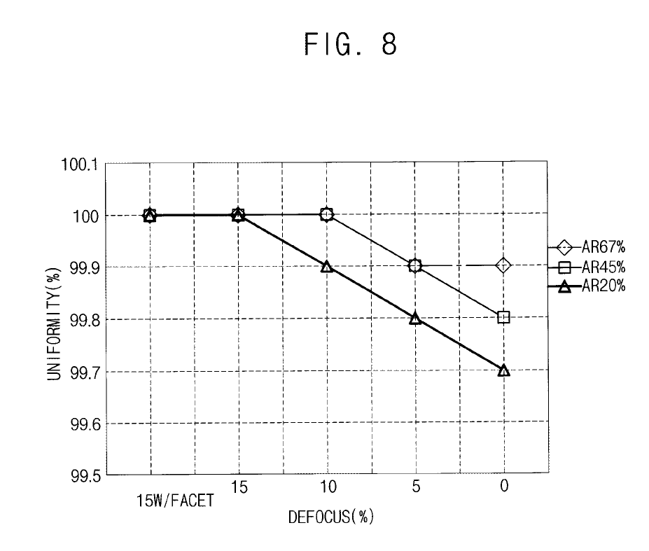

FIG. 8 is a graph illustrating a uniformity of a luminance according to a defocus in the display apparatuses according the previous example embodiments in FIGS. 1, 4 and 6.

Referring to FIG. 8, the luminance distribution was measured according to the defocus of the lens for display panels having various aperture ratios, and the display panel having relatively smaller aperture ratio was sensitive to the luminance distribution.

For example, when a lens plate having the defocus of about 15% was mounted to the display panel having relatively larger aperture ratio of about 67%, the luminance uniformity was about 100%. When the lens plate having the defocus of about 10% was mounted, the luminance uniformity was about 100%. When the lens plate having the defocus of about 5% was mounted, the luminance uniformity was about 99.9%. In the display panel having the relatively larger aperture ratio, the luminance uniformity was uniformly maintained regardless of a change of the defocus of the lens. Accordingly, the luminance uniformity is excellent regardless of a design of the lens plate, and thus the defocus of the lens plate may be removed.

When a lens plate having the defocus of about 15% was mounted to the display panel having a relatively medium aperture ratio of about 45%, the luminance uniformity was about 100%. When the lens plate having the defocus of about 10% was mounted, the luminance uniformity was about 100%. When the lens plate having the defocus of about 5% was mounted, the luminance uniformity was about 99.9%. In the display panel having the relatively larger aperture ratio, the luminance uniformity was uniformly maintained regardless of a change of the defocus of the lens. Accordingly, the luminance uniformity is excellent regardless of a design of the lens plate, and thus the defocus of the lens plate may be removed.

When a lens plate having the defocus of about 15% was mounted to the display panel having a relatively smaller aperture ratio of about 20%, the luminance uniformity was about 100%. When the lens plate having the defocus of about 10% was mounted, the luminance uniformity was about 99.9%. When the lens plate having the defocus of about 5% was mounted, the luminance uniformity was about 99.8%. In the display panel having the relatively larger aperture ratio, the luminance uniformity was uniformly maintained regardless of a change of the defocus of the lens. Accordingly, the luminance uniformity is excellent regardless of a design of the lens plate, and thus the defocus of the lens plate may be removed.

As the aperture ratio decreases, the luminance uniformity according to a deviation of the vertical width of the light blocking portion is most sensitive. Thus, the luminance uniformity of the display panel having the relatively smaller aperture ratio may be most sensitive according to the change of the defocus.

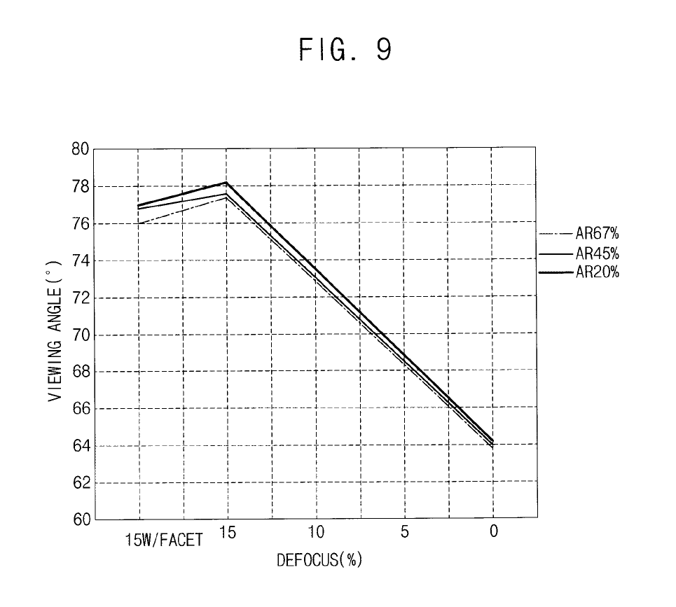

FIG. 9 is a graph illustrating a viewing angle according to the defocus in the display apparatuses according to the previous example embodiments in FIGS. 1, 4 and 6.

Referring to FIG. 9, the viewing angle was measured according to the defocus of the lens having various aperture ratios, and the viewing angle is not affected by the change of the aperture ratio.

When a lens plate having the defocus of about 15% was mounted to the display panel having a relatively larger aperture ratio of about 67%, the viewing angle was about 77°. When the lens plate having the defocus of about 10% was mounted, the viewing angle was about 73.5°. When the lens plate having the defocus of about 5% was mounted, the viewing angle was about 69.1°.

When a lens plate having the defocus of about 15% was mounted to the display panel having a relatively medium aperture ratio of about 45%, the viewing angle was about 77.5°. When the lens plate having the defocus of about 10% was mounted, the viewing angle was about 73.2°. When the lens plate having the defocus of about 5% was mounted, the viewing angle was about 68.5°.

When a lens plate having the defocus of about 15% was mounted to the display panel having a relatively smaller aperture ratio of about 20%, the viewing angle was about 78.2°. When the lens plate having the defocus of about 10% was mounted, the viewing angle was about 73.8°. When the lens plate having the defocus of about 5% was mounted, the viewing angle was about 68.7°.

Accordingly, the decrease of the viewing angle due to the decrease of the defocus is independent of the change of the aperture ratio.

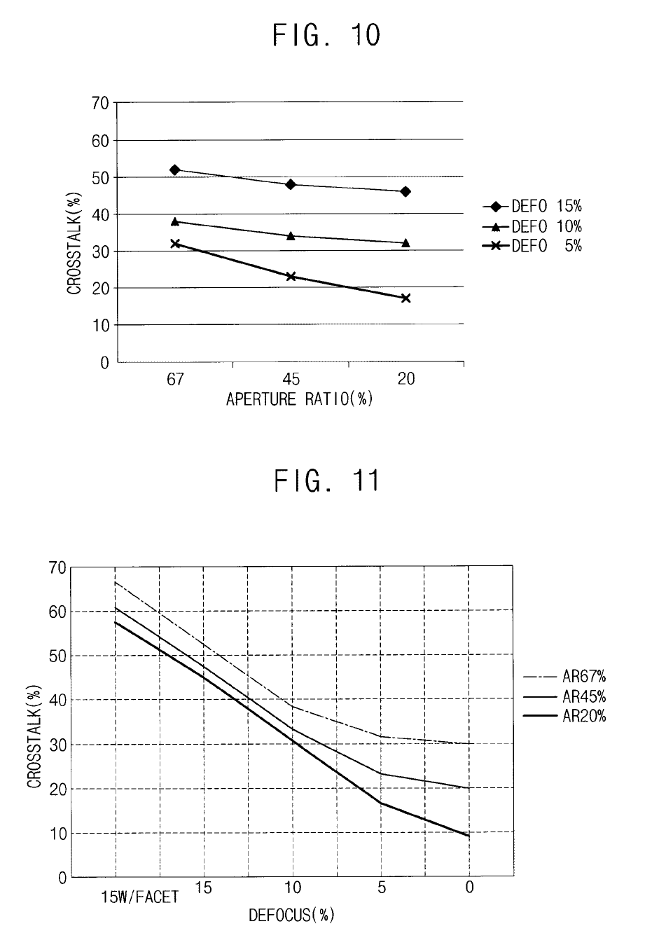

FIG. 10 is a graph illustrating a change of crosstalk factor according to different aperture ratios in the display apparatuses according to the previous example embodiments in FIGS. 1, 4 and 6 and also according to change of defocus.

Referring to FIG. 10, the crosstalk was measured according to the defocus of the lens, and the crosstalk increased as the defocus increased. The crosstalk was calculated by Equation 2 mentioned above. Here, the crosstalk was measured based on the crosstalk after the light passing through the light output-controlling portion passed through the lens, and thus the crosstalk is as recognized by the observer.

For example, when a lens plate having the defocus of about 15% was mounted to the display panel having a relatively larger aperture ratio of about 67%, the crosstalk was about 52%. When a lens plate having the defocus of about 15% was mounted to the display panel having a relatively medium aperture ratio of about 457%, the crosstalk was about 48%. When a lens plate having the defocus of about 15% was mounted to the display panel having a relatively smaller aperture ratio of about 20%, the crosstalk was about 46%. When the lens plate having the defocus of about 10% was mounted, the crosstalk was about 38% for the display panel having the relatively larger aperture, the crosstalk was about 34% for the display panel having the relatively medium aperture and the crosstalk was about 32% for the display panel having the relatively smaller aperture. When the lens plate having the defocus of about 5% was mounted, the crosstalk was about 32% for the display panel having the relatively larger aperture, the crosstalk was about 24% for the display panel having the relatively medium aperture and the crosstalk was about 18% for the display panel having the relatively smaller aperture.

Accordingly, as the defocus of the lens decreased and the aperture ratio decreased, the observable crosstalk decreased. The defocus may be in a range between about 0% and about 15% considering the crosstalk.

FIG. 11 is a graph illustrating a change of crosstalk according to the defocus in the lens used in the display apparatuses according to the previous example embodiments in FIGS. 1, 4 and 6 and where aperture ratio is also varied.

Referring to FIG. 11, the crosstalk was measured according to the defocus in each of the aperture ratios, and the crosstalk increased as the aperture ratio increased.

As for the display panel having the relatively larger aperture of about 67%, when the lens plate having the defocus of about 15% was mounted, the crosstalk was about 52%. When the lens plate having the defocus of about 10% was mounted, the crosstalk was about 49%. When the lens plate having the defocus of about 5% was mounted, the crosstalk was about 31%.

As for the display panel having the relatively medium aperture of about 45%, when the lens plate having the defocus of about 15% was mounted, the crosstalk was about 48%. When the lens plate having the defocus of about 10% was mounted, the crosstalk was about 34%. When the lens plate having the defocus of about 5% was mounted, the crosstalk was about 23%.

As for the display panel having the relatively smaller aperture of about 20%, when the lens plate having the defocus of about 15% was mounted, the crosstalk was about 45%. When the lens plate having the defocus of about 10% was mounted, the crosstalk was about 31%. When the lens plate having the defocus of about 5% was mounted, the crosstalk was about 18%.

Accordingly, as the defocus of the lens decreased and the aperture ratio decreased, the crosstalk decreased.

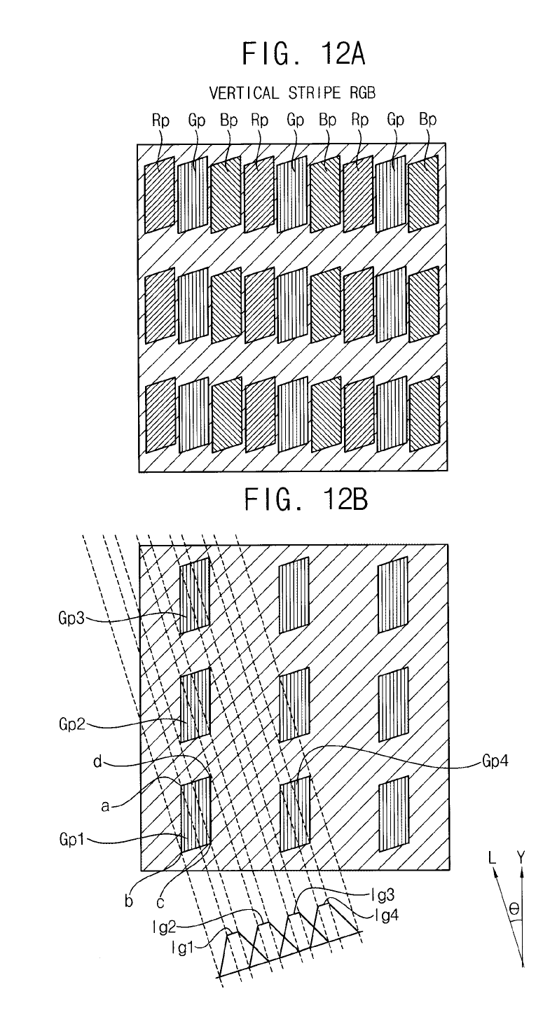

FIGS. 12A and 12B are conceptual diagrams illustrating a luminance distribution in a pixel according to still another example embodiment of the present disclosure of invention.

Referring to FIG. 12A, red, green and blue light output-controlling portions Rp, Gp and Bp of the display panel according to the present example embodiment are arranged in a vertical stripes structure (each vertical stripe has its respective color). Each of the red, green and blue light output-controlling portions Rp, Gp and Bp has a parallelogrammic shape and a vertical width of the light blocking portion of each of the red, green and blue light output-controlling portions is determined by a repetition period the light output-controlling portions and a first inclination angle θ of the lens axis L as expressed by Equation 1, like one of the previous example embodiments mentioned above.

Referring to FIG. 12B, only the contributions of the green light output-controlling portion Gp of the display panel are considered here, and luminance distributions of first, second, third and fourth green light output-controlling portions Gp1, Gp2, Gp3 and Gp4 are illustrated as an order of the positions in a line substantially parallel with the lens axis L.

The first green light output-controlling portion Gp1 has a first luminance contribution distribution plot Lg1, the second green light output-controlling portion Gp2 has a second luminance contribution distribution plot Lg2, the third green light output-controlling portion Gp3 has a third luminance contribution distribution plot Lg3, and the fourth green light output-controlling portion Gp4 has a fourth luminance contribution distribution plot Lg4.

Each of the first, second, third and fourth luminance distributions Lg1, Lg2, Lg3 and Lg4 is divided into first, second and third areas, and the third and first areas between the green light output-controlling portions Gp1, Gp2, Gp3 and Gp4 adjacent to each other overlap with each other, as mentioned referring to FIG. 2. In the first area, the luminance gradually increases. In the second area, the luminance is in the maximum level. In the third area, the luminance gradually decreases.

For example, a line from a third apex c of the third green light output-controlling portion Gp3 to a second apex b of the fourth green light output-controlling portion Gp4 is substantially parallel with the lens axis L. A line from a fourth apex d of the third green light output-controlling portion Gp3 to a first apex a of the fourth green light output-controlling portion Gp4 is substantially parallel with the lens axis L. Thus, the third area of the third luminance distribution Lg3 overlaps with the first area of the fourth luminance distribution Lg4, and an absolute value of an inclination of the third luminance distribution Lg3 is substantially same as the absolute value of an inclination of the fourth luminance distribution Lg4 in the overlapping area.

For example, a decreasing rate of the third luminance distribution Lg3 is substantially same as the increasing rate of the fourth luminance distribution Lg4, and thus the luminance distribution may be uniform.

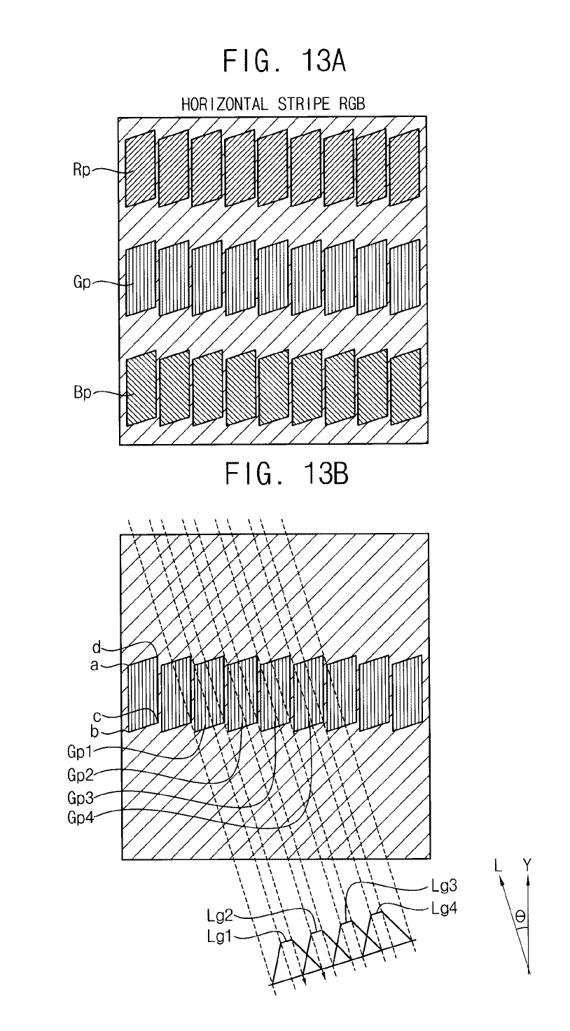

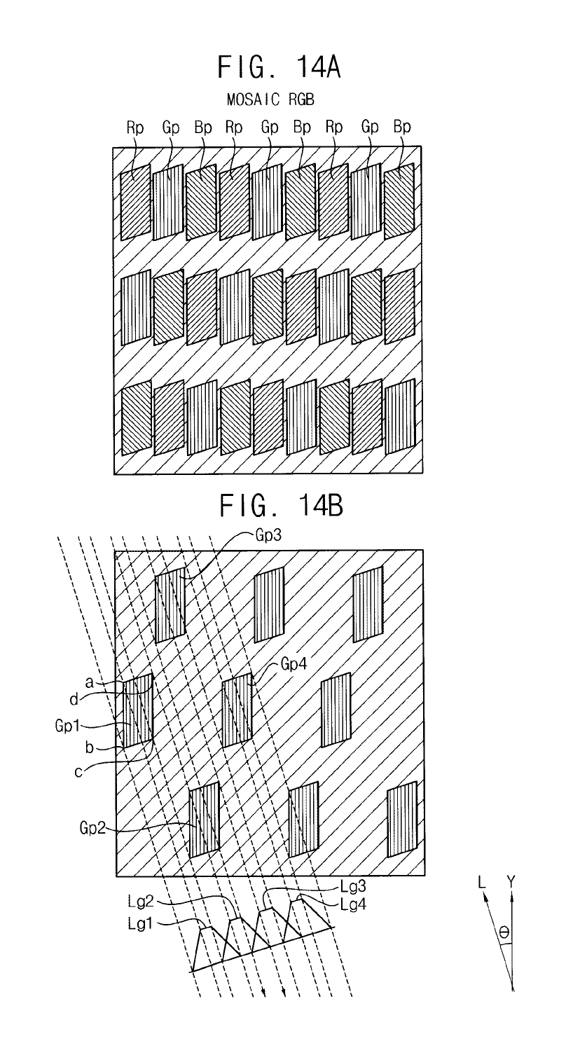

FIGS. 13A and 13B are conceptual diagrams illustrating a luminance distribution in a pixel according to still another example embodiment of the present disclosure of invention.

Referring to FIG. 13A, red, green and blue light output-controlling portions Rp, Gp and Bp of the display panel according to the present example embodiment are arranged in a horizontal stripes structure (each horizontal stripe has its own respective color). Each of the red, green and blue light output-controlling portions Rp, Gp and Bp has a parallelogrammic shape and a vertical width of the light blocking portion of each of the red, green and blue light output-controlling portions is determined by a period the light output-controlling portion and a first inclination angle θ of the lens axis L as expressed by Equation 1, like one of the previous example embodiments mentioned above.

Referring to FIG. 13B, the green light output-controlling portion Gp of the display panel is driven, and luminance distributions of first, second, third and fourth green light output-controlling portions Gp1, Gp2, Gp3 and Gp4 are illustrated as an order of the positions in a line substantially parallel with the lens axis L.

The first green light output-controlling portion Gp1 has a first luminance contribution distribution plot Lg1, the second green light output-controlling portion Gp2 has a second luminance distribution plot Lg2, the third green light output-controlling portion Gp3 has a third luminance distribution plot Lg3, and the fourth green light output-controlling portion Gp4 has a fourth luminance distribution plot Lg4.

Each of the first, second, third and fourth luminance distributions Lg1, Lg2, Lg3 and Lg4 is divided into first, second and third areas, and the third and first areas between the green light output-controlling portions Gp1, Gp2, Gp3 and Gp4 adjacent to each other overlap with each other, as mentioned referring to FIG. 2. In the first area, the luminance gradually increases. In the second area, the luminance is in the maximum level. In the third area, the luminance gradually decreases.

For example, a line from a third apex c of the first green light output-controlling portion Gp1 to a second apex b of the second green light output-controlling portion Gp2 is substantially parallel with the lens axis L. A line from a fourth apex d of the first green light output-controlling portion Gp1 to a first apex a of the second green light output-controlling portion Gp2 is substantially parallel with the lens axis L. Thus, the third area of the first luminance distribution Lg1 overlaps with the first area of the second luminance distribution Lg2, and an absolute value of an inclination of the first luminance distribution Lg1 is substantially same as the absolute value of an inclination of the second luminance distribution Lg2 in the overlapping area.

For example, decreasing rates and increasing rates of the luminance of the green light output-controlling portions adjacent to each other is substantially same with each other in the overlapping area, and thus the luminance distribution may be uniform.

FIGS. 14A and 14B are conceptual diagrams illustrating a luminance distribution in a pixel according to still another example embodiment of the present invention.

Referring to FIG. 14A, red, green and blue light output-controlling portions Rp, Gp and Bp of the display panel according to the present example embodiment are arranged in a mosaic structure so that the colors are not striped in either the vertical or horizontal directions. Each of the red, green and blue light output-controlling portions Rp, Gp and Bp has a parallelogrammic shape and a vertical width of the light blocking portion of each of the red, green and blue light output-controlling portions is determined by a period the light output-controlling portion and a first inclination angle θ of the lens axis L as expressed by Equation 1, like one of the previous example embodiments mentioned above.

Referring to FIG. 14B, the contributions of only the green light output-controlling portion Gp of the display panel are considered here, and luminance contribution distributions of first, second, third and fourth green light output-controlling portions Gp1, Gp2, Gp3 and Gp4 are illustrated as an order of the positions in a line substantially parallel with the lens axis L.

The first green light output-controlling portion Gp1 has a first luminance distribution plot Lg1, the second green light output-controlling portion Gp2 has a second luminance distribution plot Lg2, the third green light output-controlling portion Gp3 has a third luminance distribution plot Lg3, and the fourth green light output-controlling portion Gp4 has a fourth luminance distribution plot Lg4.

Each of the first, second, third and fourth luminance distributions Lg1, Lg2, Lg3 and Lg4 is divided into first, second and third areas, and the third and first areas between the green light output-controlling portions Gp1, Gp2, Gp3 and Gp4 adjacent to each other overlap with each other, as mentioned referring to FIG. 2. In the first area, the luminance gradually increases. In the second area, the luminance is in the maximum level. In the third area, the luminance gradually decreases.

For example, a line from a third apex c of the second green light output-controlling portion Gp2 to a second apex b of the third green light output-controlling portion Gp3 is substantially parallel with the lens axis L. A line from a fourth apex d of the second green light output-controlling portion Gp2 to a first apex a of the third green light output-controlling portion Gp3 is substantially parallel with the lens axis L. Thus, the third area of the second luminance distribution Lg2 overlaps with the first area of the third luminance distribution Lg3, and an absolute value of an inclination of the second luminance distribution Lg2 is substantially same as the absolute value of an inclination of the third luminance distribution Lg3 in the overlapping area.

For example, decreasing rates and increasing rates of the luminance of the green light output-controlling portions adjacent to each other is substantially same with each other in the overlapping area, and thus the luminance distribution may be uniform.

As mentioned referring to FIGS. 12A to 14B, the luminance is perceived by the user to be uniformly distributed in the vertical stripe structure, in the horizontal stripe structure and in the mosaic structure.

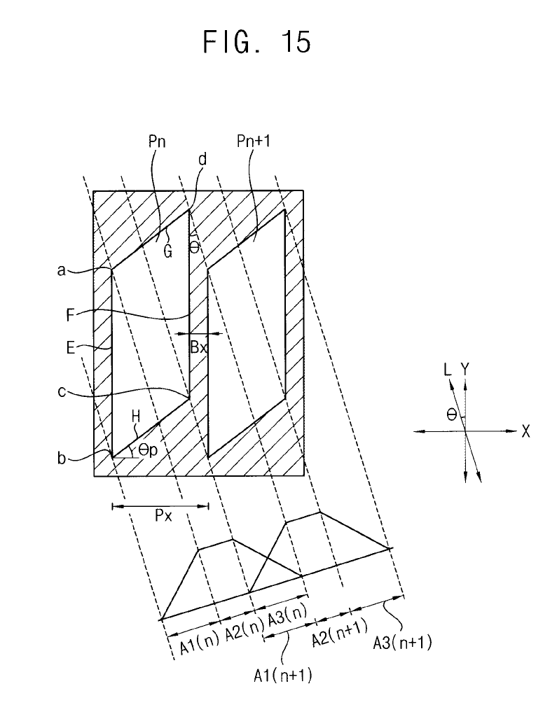

FIG. 15 is a plan view illustrating a display panel according to still another example embodiment of the present invention.

Referring to FIG. 15, the display panel according to the present example embodiment includes a plurality of light output-controlling portions Pn−1 and Pn arranged in the horizontal-axis direction X. Here, n is a natural number.

For example, the (n)th light output-controlling portion Pn has first, second, third and fourth apexes a, b, c and d, and includes a first long side E, a second long side F, a first short side G and a second short side H. The first long side E connects the first and second apexes a and b with each other. The second long side F connects the third and fourth apexes c and d with each other. The first short side G connects the first and fourth apexes a and d with each other. The second short side H connects the second and third apexes b and c with each other. The first and second long sides E and F are substantially parallel with the vertical-axis direction Y. The first and second short sides G and H are inclined with respect to the horizontal-axis direction X by a second inclination angle θp. The light blocking portion B disposed between the second long side F of the (n)th light output-controlling portion Pn and the first long side E of the (n+1)th light output-controlling portion Pn+1 has a vertical width Bx, and has a period Px of the light output-controlling portion between the (n+1)th light output-controlling portion Pn+1 and the (n)th light output-controlling portion Pn.

The second inclination angle θp may be calculated by Equation 3 as follows.

$$θ p = arctan [ \frac{{B}_{x}}{tan θ ( {P}_{x} - {B}_{x} )} ] \qquad [ Equation 3 ]$$

In Equation 3, the horizontal width Bx of the light blocking portion B may be variously determined by the second inclination angle θp. For example, the horizontal width Bx may increase as the second inclination angle θp increases.

A line from the fourth apex d of the (n−1)th light output-controlling portion Pn−1 to the first apex a of the (n)th light output-controlling portion Pn is substantially parallel with the lens axis L. A line from the third apex c of the (n−1)th light output-controlling portion Pn−1 to the second apex b of the (n)th light output-controlling portion Pn is substantially parallel with the lens axis L. A line from the fourth apex d of the (n)th light output-controlling portion Pn to the first apex a of the (n+1)th light output-controlling portion Pn+1 is substantially parallel with the lens axis L. A line from the third apex c of the (n)th light output-controlling portion Pn to the second apex b of the (n+1)th light output-controlling portion Pn+1 is substantially parallel with the lens axis L.

The (n)th light output-controlling portion Pn displays an (n)th viewing-point image, and a luminance contribution distribution of the (n)th light output-controlling portion Pn is divided into first, second and third areas A1n, A2n and A3n, by action of the unit lens UL having the lens axis L. In the first area A1n of the (n)th light output-controlling portion Pn, the luminance gradually increases to a maximum level due to the light blocking portion B and the (n−1)th light output-controlling portion Pn−1. In the second area A2n of the (n)th light output-controlling portion Pn, the luminance is in the maximum level. In the third area A3n of the (n)th light output-controlling portion Pn, the luminance gradually decreases from the maximum level due to the light blocking portion B and the (n)th light output-controlling portion Pn.

The (n+1)th light output-controlling portion Pn+1 displays the (n+1)th viewing-point image, and a luminance distribution of the (n+1)th light output-controlling portion Pn+1 is divided into first, second and third areas A1(n+1), A2(n+1) and A3(n+1), by action of the unit lens UL having the lens axis L. In the first area A1(n+1) of the (n+1)th light output-controlling portion Pn+1, the luminance gradually increases to a maximum level due to the (n)th light output-controlling portion Pn and the light blocking portion B. In the second area A2(n+1) of the (n+1)th light output-controlling portion Pn+1, the luminance is in the maximum level. In the third area A3(n+1) of the (n+1)th light output-controlling portion Pn+1, the luminance gradually decreases from the maximum level due to the light blocking portion B and the (n+2)th light output-controlling portion Pn+2.

The third area A3n of the (n)th light output-controlling portion Pn overlaps with the first area A1(n+1) of the (n+1)th light output-controlling portion Pn+1. In the third area A3n of the (n)th light output-controlling portion Pn, the luminance gradually decreases from the maximum level, but in the first area A1(n+1) of the (n+1)th light output-controlling portion Pn+1, the luminance gradually increases to a maximum level. Thus, the luminance may be uniformly distributed, and thus Moiré may be prevented from occurring due to an un-uniform distribution of the luminance.

According to the present example embodiment, the luminance is uniformly distributed and the horizontal width Bx is differently determined, compared to the previous example embodiment in FIG. 2. Thus, the horizontal width Bx may be changed considering a processing margin.

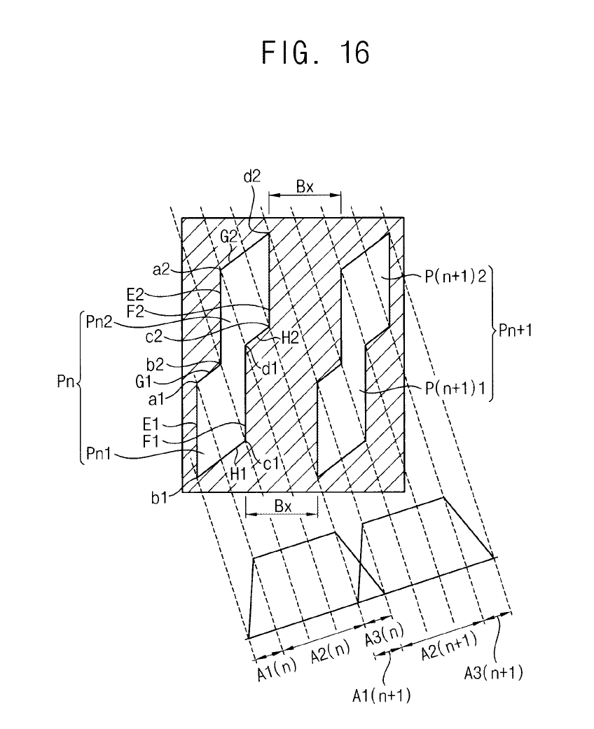

FIG. 16 is a plan view illustrating a display panel according to still another example embodiment of the present invention where the light output-controlling portions, Pn−1, Pn, etc. have non-rectangular shapes.

Referring to FIG. 16, the display panel includes a plurality of light output-controlling portions Pn−1 and Pn arranged in the vertical-axis direction X. Here, n is a natural number.

For example, the (n)th light output-controlling portion Pn has a shape of two substantially same parallelograms connected midway with each other by a channel section. The (n)th light output-controlling portion Pn includes a first parallelogrammic area Pn1 and a second parallelogrammic area Pn2.

The first parallelogrammic area Pn1 has first, second, third and fourth apexes a1, b1, c1 and d1, and includes a first long side E1, a second long side F1, a first short side G1 and a second short side H1. The first long side E1 connects the first and second apexes a1 and b1 with each other. The second long side F1 connects the third and fourth apexes c1 and d1 with each other. The first short side G1 connects the first and fourth apexes a1 and d1 with each other. The second short side H1 connects the second and third apexes b1 and c1 with each other. The first parallelogrammic area Pn1 may be defined by Equation 3.

The second parallelogrammic area Pn2 has first, second, third and fourth apexes a2, b2, c2 and d2, and includes a first long side E2, a second long side F2, a first short side G2 and a second short side H2. The first long side E2 connects the first and second apexes a2 and b2 with each other. The second long side F2 connects the third and fourth apexes c2 and d2 with each other. The first short side G2 connects the first and fourth apexes a2 and d2 with each other. The second short side H2 connects the second and third apexes b2 and c2 with each other. The first parallelogrammic area Pn2 may be defined by Equation 3.

The (n+1)th light output-controlling portion Pn+1 includes first and second parallelogrammic areas P(n+1)1 and P(n+1)2. The first and second parallelogrammic areas P(n+1)1 and P(n+1)2 have structures substantially same as those of the first and second parallelogrammic areas Pn1 and Pn2, respectively. The vertical width Bx of the light blocking portion between the (n)th and (n+1)th light output-controlling portions Pn and Pn+1 may be defined by Equation 3.

The display panel according to the present example embodiment may have the uniform luminance distribution as mentioned above in the previous example embodiment in FIG. 15. In addition, the light output-controlling portion in the present example embodiment has the shape of two parallelograms connected with each other, but not limited thereto.

According to the above-mentioned example embodiments, the light output-controlling portion designed using Equation 1 or Equation 3 may have uniform luminance distribution regardless of the change of the defocus of the lens. Thus, Moiré effect may be substantially suppressed or prevented from occurring due to an un-uniform distribution of the luminance contributions. In addition, the aperture ratio and the defocus of the lens may be controlled in the display panel, so that the crosstalk in the 3D stereoscopic image may be improved.

The foregoing is illustrative of the present disclosure of invention and is not to be construed as limiting thereof. Although a few example embodiments of the present disclosure have been described, those skilled in the art will readily appreciate from the foregoing that many modifications are possible in the example embodiments without materially departing from the novel teachings and advantages of the present disclosure of invention. Accordingly, all such modifications are intended to be included within the scope of the present teachings. In the claims, means-plus-function clauses are intended to cover the structures described herein as performing the recited function and not only structural equivalents but also functionally equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the spirit and scope of the present teachings.

What is claimed is:

1. A display panel having a vertical-axis direction and a horizontal-axis direction, the display panel being capable of producing imagery that can be perceived as 3D imagery by a viewer and comprising:
a plurality of light output-controlling portions each having a non-rectangular shape, the shape including a first long side extending in the vertical-axis direction, a spaced apart second long side substantially parallel with, but no vertically aligned with the first long side, a first short side that is shorter than the first and second long sides and extends along a non-horizontal direction that is the horizontal-axis direction, and a second short side spaced apart from and substantially parallel with the first short side, each light output-controlling portion being configured to selectively control light output therefrom or transmitted therethrough; and
a light blocking portion surrounding the light output-controlling portions, the light blocking portion being configured to block light from passing therethrough or being reflected therefrom.

2. The display panel of claim 1, wherein each of the light output-controlling portions has a parallelogram shape with respective first through fourth apexes and the first long side connects the first and second apexes of the light output-controlling portion with each other, the second long side connects the third and fourth apexes of the light output-controlling portion with each other, the first short side connects the first and fourth apexes of the light output-controlling portion with each other, and the second short side connects the second and third apexes of the light output-controlling portion with each other.

3. The display panel of claim 2, wherein the plurality of light output-controlling portions includes an (n−1)th light output-controlling portion, an (n)th light output-controlling portion and an (n+1)th light output-controlling portion extending along the horizontal-axis direction, where n is a natural number,
wherein the first apex of the (n)th light output-controlling portion and the fourth apex of the (n−1)th light output-controlling portion are in alignment with a first hypothetical line, the second apex of the (n)th light output-controlling portion and the third apex of the (n−1)th light output-controlling portion are in alignment with a second hypothetical line, the third apex of the (n)th light output-controlling portion and the second apex of the (n+1)th light output-controlling portion are in alignment with a third hypothetical line, and the fourth apex of the (n)th light output-controlling portion and the first apex of the (n+1)th light output-controlling portion are in alignment with a fourth hypothetical line.

4. The display panel of claim 3, wherein the first, second, third and fourth hypothetical lines are substantially parallel with each other and are inclined by a second inclination angle with respect to the vertical-axis direction of the display panel.

5. The display panel of claim 4, wherein a horizontal width (Bx) of the light blocking portion disposed between the light output-controlling portions adjacent to each other along the horizontal-axis direction is determined by a repetition period of the light output-controlling portions and by the second inclination angle.

6. The display panel of claim 4, wherein the second inclination angle is determined by a horizontal width (Bx) of the light blocking portion disposed between the light output-controlling portions adjacent to each other along the horizontal-axis direction, by a repetition period of the light output-controlling portions and by the first inclination angle.

7. The display panel of claim 1, further comprising at least one electronic element and at least one signal line configured to drive a respective pixel electrode included in a respective one of the light output-controlling portions,
wherein the electronic element and the signal line are disposed in an area in which the light blocking portion is disposed.

8. A display apparatus capable of producing imagery that can be perceived as 3D imagery by a viewer and comprising:
a lens plate comprising a plurality of unit lenses, each unit lens having a lens axis inclined by a first inclination angle with respect to a vertical-axis direction; and
a display panel having the vertical-axis direction as one of its orthogonal display axes and facing the lens plate and comprising a plurality of light output-controlling portions and a light blocking portion, each light output-controlling portion having and non-rectangular shape and including a first long side extending along the vertical-axis direction, a second long side substantially parallel with the first long side, a first short side extending along a direction inclined by a second inclination angle with respect to a horizontal-axis direction, and a second short side substantially parallel with the first short side, the light blocking portion surrounding the light output-controlling portions.

9. The display apparatus of claim 8, wherein the first long side connects first and second apexes of the light output-controlling portion with each other, the second long side connects third and fourth apexes of the light output-controlling portion with each other, the first short side connects the first and fourth apexes of the light output-controlling portion with each other, and the second short side connects the second and third apexes of the light output-controlling portion with each other.

10. The display apparatus of claim 9, wherein the plurality of light output-controlling portions includes an (n−1)th light output-controlling portion, an (n)th light output-controlling portion and an (n+1)th light output-controlling portion extending along the horizontal-axis direction (n is a natural number),
wherein the first apex of the (n)th light output-controlling portion and the fourth apex of the (n−1)th light output-controlling portion are in alignment with a first line, the second apex of the (n)th light output-controlling portion and the third apex of the (n−1)th light output-controlling portion are in alignment with a second line, the third apex of the (n)th light output-controlling portion and the second apex of the (n+1)th light output-controlling portion are in alignment with a third line, and the fourth apex of the (n)th light output-controlling portion and the first apex of the (n+1)th light output-controlling portion are in alignment with a fourth line.

11. The display apparatus of claim 10, wherein the first, second, third and fourth lines are substantially parallel with the lens axis.

12. The display apparatus of claim 8, wherein a horizontal width (Bx) of the light blocking portion between the light output-controlling portions adjacent to each other along the horizontal-axis direction is determined by a repetition period of the light output-controlling portions and by the first inclination angle.

13. The display apparatus of claim 12, wherein the second inclination angle is substantially the same as the first inclination angle.

14. The display apparatus of claim 12, wherein the horizontal width (Bx) of the light blocking portion is calculated by:
Bₓ=Pₓ sin²θ
wherein Px is the period of the light output-controlling portions and θ is the first inclination angle.

15. The display apparatus of claim 8, wherein the second inclination angle is determined by a horizontal width of the light blocking portion between the light output-controlling portions adjacent to each other along the horizontal-axis direction, a period of the light output-controlling portion and the first inclination angle.

16. The display apparatus of claim 15, wherein the second inclination angle (θp) is calculated by:
$$θ p = arctan [ \frac{{B}_{x}}{tan θ ( {P}_{x} - {B}_{x} )} ]$$
wherein Px is the period of the light output-controlling portions, Bx is the horizontal width of the light blocking portion and θ is the first inclination angle.

17. The display apparatus of claim 8, wherein the light output-controlling portions include red, green and blue light output-controlling portions, and the red, green and blue light output-controlling portions are arranged in a vertical stripes pattern.

18. The display apparatus of claim 8, wherein the light output-controlling portions include red, green and blue light output-controlling portions, and the red, green and blue light output-controlling portions are arranged in a horizontal stripes pattern.

19. The display apparatus of claim 8, wherein the light output-controlling portions include red, green and blue light output-controlling portions, and the red, green and blue light output-controlling portions are arranged in a mosaic pattern.

20. The display apparatus of claim 8, wherein the display panel further comprises at least one electronic element and at least one signal line configured for driving a respective pixel electrode included in a respective one of the light output-controlling portions,
wherein the electronic element and the signal line are disposed in an area in which the light blocking portion is disposed.
